(19) United States
(12) Patent Application Publication
(10) Pub. No.: US 2016/0258828 A1
(43) Pub. Date: Sep. 8, 2016

(54) PRESSURE SENSOR, PORTABLE APPARATUS, ELECTRONIC APPARATUS, AND MOVING OBJECT

(71) Applicant: Seiko Epson Corporation, Tokyo (JP)

(72) Inventor: Junichi TAKEUCHI, Chino (JP)

(21) Appl. No.: 15/059,656

(22) Filed: Mar. 3, 2016

(30) Foreign Application Priority Data
Mar. 4, 2015 (JP) 2015-042850

(51) Int. Cl. G01L 9/00

(52) U.S. Cl. CPC G01L 9/0054

(57) ABSTRACT

A pressure sensor includes two diaphragm portions that are deflected and deformed under pressure. Pressure receiving surfaces of the two diaphragm portions are arranged to be oriented in different directions. Piezoresistive elements disposed in one of the diaphragm portions are connected in series with piezoresistive elements disposed in the other diaphragm portion.

### CROSS REFERENCE

This application claims the benefit of Japanese Application No. 2015-042850, filed on Mar. 4, 2015. The disclosure of the prior application is hereby incorporated by reference herein in its entirety.

### BACKGROUND

1. Technical Field

The present invention relates to a pressure sensor, a portable apparatus, an electronic apparatus, and a moving object.

2. Related Art

Pressure sensors including a diaphragm that is deflected and deformed under pressure are widely used. In the pressure sensor, for example, the pressure applied to the diaphragm is detected based on the resistance values of piezoresistive elements disposed in the diaphragm. Here, when acceleration such as gravitational acceleration is applied to the diaphragm, the amount of deflection of the diaphragm varies under the influence of the acceleration, and thus the accuracy of the detected pressure may be lowered.

Therefore, in the related art as disclosed in JP-A-8-261852, the improvement of detection accuracy is achieved as follows: two pressure sensors are disposed such that their pressure receiving surfaces are opposed to each other; electrical signals are output from the respective pressure sensors; and then, these outputs are added together to thereby cancel out the output component of the gravitational acceleration.

In the configuration disclosed in JP-A-8-261852, however, it is necessary to output the electrical signals from the two respective pressure sensors, and therefore, a circuit configuration is complicated, resulting in a problem of difficulty in power saving.

### SUMMARY

An advantage of some aspects of the invention is to provide a pressure sensor having excellent detection accuracy while achieving power saving, and provide a portable apparatus, an electronic apparatus, and a moving object that include the pressure sensor.

The advantage can be achieved by the invention described below.

### Application Example 1

A pressure sensor according to this application example of the invention includes: a first diaphragm portion including a first pressure receiving surface, the first diaphragm portion being deflected and deformed under a pressure received by the first pressure receiving surface; a second diaphragm portion including a second pressure receiving surface arranged to be oriented in a direction different from the first pressure receiving surface, the second diaphragm portion being deflected and deformed under a pressure received by the second pressure receiving surface; a first strain detecting element disposed in the first diaphragm portion and outputting a signal in response to a strain; and a second strain detecting element disposed in the second diaphragm portion and outputting a signal in response to a strain, the second strain detecting element being connected in series to the first strain detecting element.

According to the pressure sensor, the first pressure receiving surface of the first diaphragm portion and the second pressure receiving surface of the second diaphragm portion are arranged to be oriented in directions different from each other. Therefore, the variation amounts of the output of the first strain detecting element and the output of the second strain detecting element generated when acceleration such as gravitational acceleration acts on the pressure sensor can be canceled out each other or reduced. Therefore, the influence of acceleration such as gravitational acceleration is reduced, and thus the pressure can be detected with high accuracy.

Furthermore, since the first strain detecting element and the second strain detecting element are electrically connected, one signal in which the above-described influence of acceleration such as gravitational acceleration is reduced can be output from the pressure sensor. Therefore, compared with the case where the respective signals of the first strain detecting element and the second strain detecting element are output from the pressure sensor, a circuit configuration in the pressure sensor is simplified, and as a result, the power saving of the pressure sensor can be achieved.

### Application Example 2

In the pressure sensor according to the application example of the invention, it is preferable that the pressure sensor includes a plurality of sets of the first strain detecting element and the second strain detecting element connected in series.

With this configuration, the detection accuracy can be more increased.

### Application Example 3

In the pressure sensor according to the application example of the invention, it is preferable that the pressure sensor includes the first strain detecting element whose output signal increases when the pressure received by the first pressure receiving surface increases; the first strain detecting element whose output signal decreases when the pressure received by the first pressure receiving surface increases; the second strain detecting element whose output signal increases when the pressure received by the second pressure receiving surface increases, and which is connected in series with the first strain detecting element whose signal increases; and the second strain detecting element whose output signal decreases when the pressure received by the second pressure receiving surface increases, and which is connected in series with the first strain detecting element whose signal decreases.

With this configuration, the detection accuracy can be further increased.

### Application Example 4

In the pressure sensor according to the application example of the invention, it is preferable that the pressure sensor includes a bridge circuit including the first strain detecting element and the second strain detecting element.

With this configuration, the variation amounts of the output of the first strain detecting element and the output of the second strain detecting element generated when acceleration such as gravitational acceleration acts on the pressure sensor can be canceled out each other or reduced in one bridge circuit.

### Application Example 5

In the pressure sensor according to the application example of the invention, it is preferable that the pressure sensor includes a first pressure reference chamber including a wall portion a portion of which is configured of the first diaphragm portion; and a second pressure reference chamber including a wall portion a portion of which is configured of the second diaphragm portion.

With this configuration, an absolute pressure sensor can be realized.

### Application Example 6

In the pressure sensor according to the application example of the invention, it is preferable that the first pressure reference chamber and the second pressure reference chamber are in communication with each other.

With this configuration, the pressure in the first pressure reference chamber and the pressure in the second pressure reference chamber can be easily equal to each other, and the first diaphragm portion and the second diaphragm portion can be deflected and deformed with the common pressure as a reference. Therefore, the pressure sensor can be easily designed or manufactured.

### Application Example 7

In the pressure sensor according to the application example of the invention, it is preferable that at least one of the first pressure reference chamber and the second pressure reference chamber includes a wall portion having a stacked structure.

With this configuration, the pressure sensor of small size can be manufactured easily and with high accuracy using a semiconductor manufacturing process such as a CMOS process.

### Application Example 8

In the pressure sensor according to the application example of the invention, it is preferable that the pressure sensor includes a substrate supporting a first structure including the first diaphragm portion and a second structure including the second diaphragm portion.

With this configuration, the first pressure receiving surface and the second pressure receiving surface can be stably held in desired orientations. Moreover, the first strain detecting element and the second strain detecting element can be electrically connected via the substrate. Then, one signal in which the influence of acceleration such as gravitational acceleration is reduced can be output from the substrate.

### Application Example 9

In the pressure sensor according to the application example of the invention, it is preferable that the first structure is disposed on one surface side of the substrate, and that the second structure is disposed on the other surface side of the substrate.

With this configuration, it becomes easy to install the first structure and the second structure on the substrate such that the first pressure receiving surface and the second pressure receiving surface are opposed to each other.

### Application Example 10

In the pressure sensor according to the application example of the invention, it is preferable that the first structure and the second structure are both disposed on one surface side of the substrate.

With this configuration, the low profile of the pressure sensor can be achieved.

### Application Example 11

In the pressure sensor according to the application example of the invention, it is preferable that the pressure sensor includes a container including an opening and accommodating a first structure including the first diaphragm portion and a second structure including the second diaphragm portion.

With this configuration, the first structure and the second structure can be protected.

### Application Example 12

In the pressure sensor according to the application example of the invention, it is preferable that the pressure sensor includes a pressure transmission medium in the form of liquid or gel covering at least the first pressure receiving surface and the second pressure receiving surface in the container.

With this configuration, it is possible to strengthen the protection of the first structure and the second structure while enabling pressure transmission to the first pressure receiving surface and the second pressure receiving surface.

### Application Example 13

A portable apparatus according to this application example of the invention includes the pressure sensor according to the application example of the invention.

According to the portable apparatus, the pressure sensor can reduce the influence of acceleration such as gravitational acceleration and thus detect pressure with high accuracy, irrespective of the usage conditions of the user (e.g., the posture of the portable apparatus), the mounting orientation of the pressure sensor, or the like. Moreover, since the pressure sensor is power-saving, the miniaturization of the portable apparatus can be achieved, or the design flexibility of the portable apparatus can be increased.

### Application Example 14

An electronic apparatus according to this application example of the invention includes the pressure sensor according to the application example of the invention.

According to the electronic apparatus, the pressure sensor is power-saving, and can reduce the influence of acceleration such as gravitational acceleration and thus detect pressure with high accuracy.

### Application Example 15

A moving object according to this application example of the invention includes the pressure sensor according to the application example of the invention.

According to the moving object, the pressure sensor is power-saving, and can reduce the influence of acceleration such as gravitational acceleration and thus detect pressure with high accuracy.

### BRIEF DESCRIPTION OF THE DRAWINGS

The invention will be described with reference to the accompanying drawings, wherein like numbers reference like elements.

FIG. 1 is a cross-sectional view showing a pressure sensor according to a first embodiment of the invention.

FIG. 2 is a cross-sectional view showing a main portion of the pressure sensor shown in FIG. 1.

FIG. 3 is a plan view showing the arrangement of piezoresistive elements (strain detecting elements) in a diaphragm portion of a pressure sensor element shown in FIG. 2.

FIG. 4 is a diagram showing a circuit including the piezoresistive elements shown in FIG. 3.

FIGS. 5A and 5B are diagrams for explaining the operation of the pressure sensor element shown in FIG. 2, in which FIG. 5A is a cross-sectional view showing a pressurized state and FIG. 5B is a plan view showing the pressurized state.

FIG. 6 is a graph for explaining the operation of the pressure sensor shown in FIG. 1, showing the relationship between the acceleration applied to the pressure sensor and the detected pressure.

FIG. 7 is a cross-sectional view showing a main portion of a pressure sensor according to a second embodiment of the invention.

FIG. 8 is a cross-sectional view showing a main portion of a pressure sensor according to a third embodiment of the invention.

FIG. 9 is a cross-sectional view showing a main portion of a pressure sensor according to a fourth embodiment of the invention.

FIG. 10 is a diagram showing a circuit including piezoresistive elements of a pressure sensor element shown in FIG. 9.

FIG. 11 is a cross-sectional view showing a main portion of a pressure sensor according to a fifth embodiment of the invention.

FIG. 12 is a cross-sectional view showing a modified example of the main portion shown in FIG. 11.

FIG. 13 is a cross-sectional view showing a pressure sensor according to a sixth embodiment of the invention.

FIG. 14 is a plan view showing a main portion of the pressure sensor shown in FIG. 13.

FIG. 15 is a perspective view showing an example of a portable apparatus according to the invention.

FIG. 16 is an elevation view showing an example of an electronic apparatus according to the invention.

FIG. 17 is a perspective view showing an example of a moving object according to the invention.

### DESCRIPTION OF EXEMPLARY EMBODIMENTS

Hereinafter, a pressure sensor, a portable apparatus, an electronic apparatus, and a moving object according to the invention will be described in detail based on embodiments shown in the accompanying drawings.

### First Embodiment

### 1. Pressure Sensor

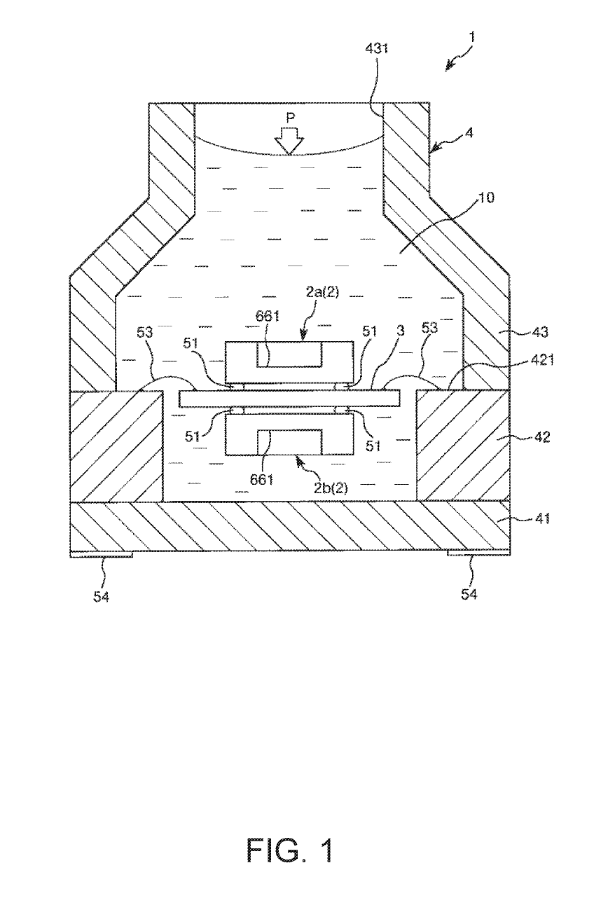

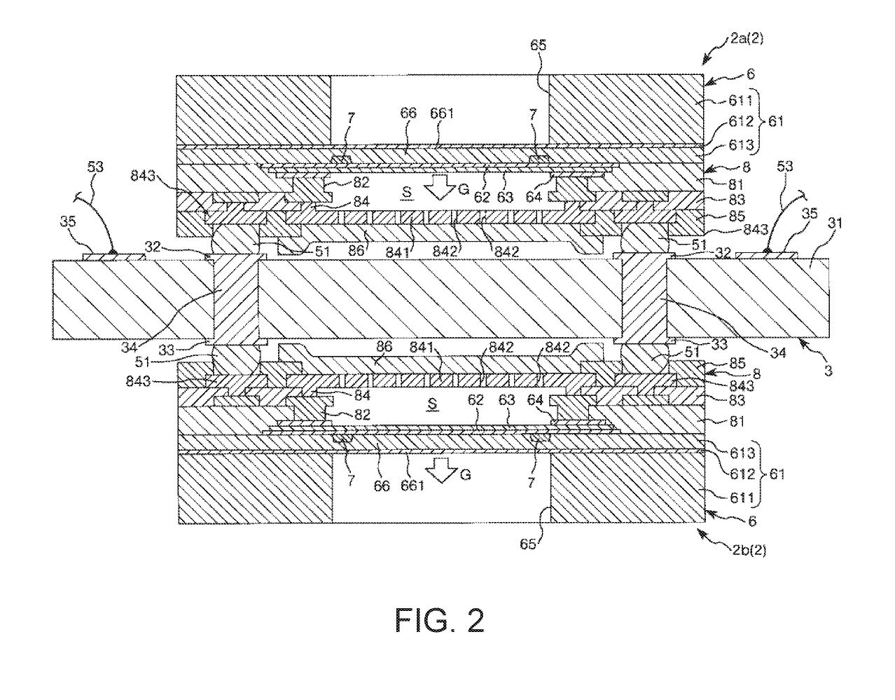

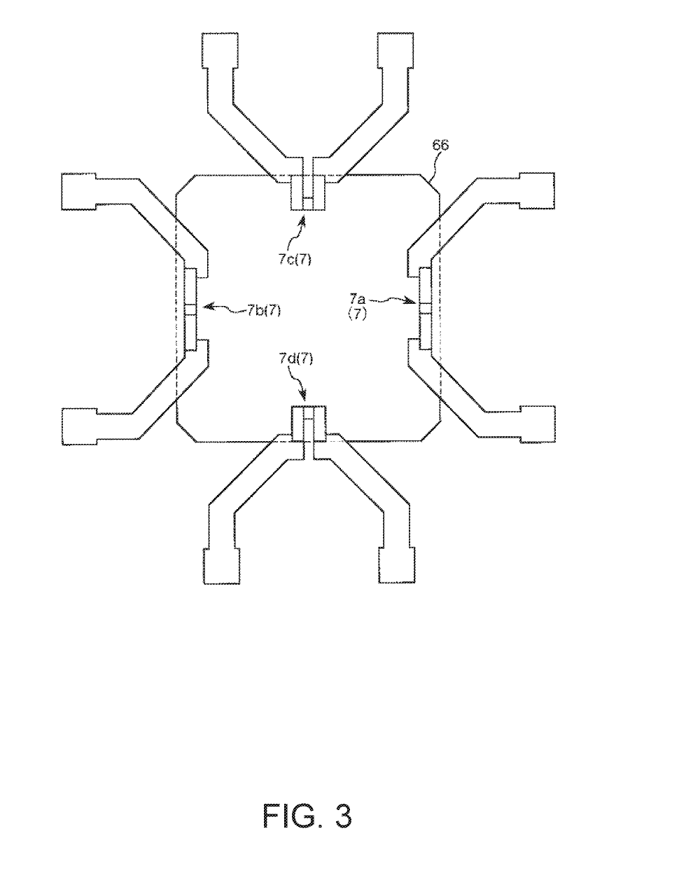

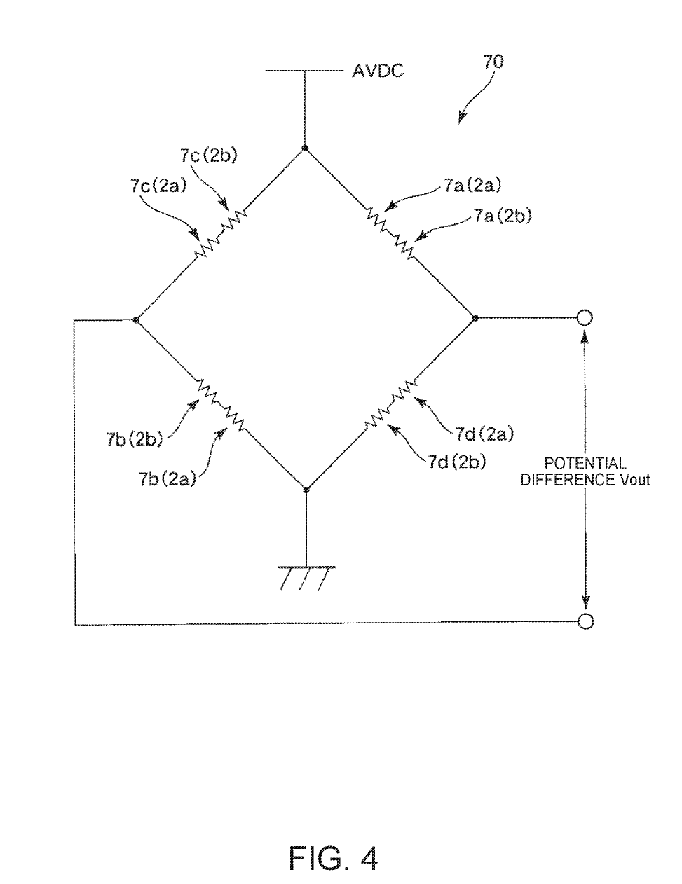

FIG. 1 is a cross-sectional view showing a pressure sensor according to a first embodiment of the invention. FIG. 2 is a cross-sectional view showing a main portion of the pressure sensor shown in FIG. 1. FIG. 3 is a plan view showing the arrangement of piezoresistive elements (strain detecting elements) in a diaphragm portion of a pressure sensor element shown in FIG. 2. FIG. 4 is a diagram showing a circuit including the piezoresistive elements shown in FIG. 3. In the following, the upper side in FIG. 1 is defined as “top”, while the lower side is defined as “bottom”, for convenience of description.

The pressure sensor 1 shown in FIG. 1 includes two pressure sensor elements 2 (2a and 2b), a substrate 3 that supports the two pressure sensor elements 2, a casing 4 (container) that accommodates the two pressure sensor elements 2 and the substrate 3, and a pressure transmission medium 10 filled in the casing 4. These parts will be successively described below.

### Casing

The casing 4 has the functions of accommodating and supporting the two pressure sensor elements 2 and the substrate 3. Due to this, the pressure sensor elements 2 can be protected.

The casing 4 includes an opening 431. Due to this, the pressure outside the casing 4 can be transmitted through the opening 431 to the pressure sensor elements 2 in the casing 4.

As shown in FIG. 1, the casing 4 includes a plate-like base 41, a frame-like frame body 42 bonded to one of the surfaces of the base 41, and a tubular cylindrical body 43 bonded to the surface of the frame body 42 on the side opposite to the base 41.

A plurality of external terminals 54 made of metal are provided on the lower surface of the base 41. On the other hand, the frame body 42 is bonded to the upper surface of the base 41. The inside width of the frame body 42 is narrower than the inside width of the lower edge of the cylindrical body 43, and a step 421 is formed between the upper surface of the base 41 and the upper surface of the frame body 42. A plurality of internal terminals (not shown) made of metal are provided on the step 421. The internal terminals are electrically connected to the external terminals 54 described above via wires (not shown) embedded in the base 41 and the frame body 42.

The constituent material of the base 41 and the frame body 42 is not particularly limited. Examples thereof include, for example, insulating materials such as various kinds of ceramics like oxide ceramics such as alumina, silica, titania, and zirconia, and nitride ceramics such as silicon nitride, aluminum nitride, and titanium nitride, and various kinds of resin materials such as polyethylene, polyamide, polyimide, polycarbonate, acrylic resin, ABS resin, and epoxy resin, and one kind or two or more kinds of these materials can be used in combination. Among them, various kinds of ceramics are preferably used. Due to this, the casing 4 having excellent mechanical strength can be realized. The plan-view shape of the base 41 and the frame body 42 is not particularly limited, and the base 41 and the frame body 42 may have, for example, a circular shape, a rectangular shape, a five- or more-sided polygonal shape, or the like.

The cylindrical body 43 includes a portion whose inside and outside widths (inside diameter and outside diameter) become narrow from the lower edge toward the upper edge, and a port ion whose inside and outside widths are constant from the above-described portion toward the upper edge. The shape of the cylindrical body 43 is not limited to this shape. For example, the cylindrical body 43 may be composed only of the portion having the constant width or may be composed only of the portion having the width narrowed toward the upper edge.

The constituent material of the cylindrical body 43 is not particularly limited, but materials similar to the above-described constituent materials of the base 41 and the frame body 42 can be used.

### Pressure Transmission Medium

The pressure transmission medium 10 is filled in the casing 4 described above so as to cover the outer surfaces (at least pressure receiving surfaces 661 described later) of the pressure sensor elements 2 and the like, and has the function of transmitting the pressure outside the casing 4 to the pressure sensor elements 2.

The pressure transmission medium 10 is in the form of liquid or gel, and made of, for example, a resin material such as silicone resin. The pressure transmission medium 10 includes portion exposed through the opening 431 of the casing 4, and transmits the pressure applied to the exposed portion to the pressure sensor elements 2 (more specifically, the pressure receiving surfaces 661 of diaphragm portions 66 described later). The resin material of which the pressure transmission medium 10 is made may contain a filler in the form of solid (powder) made of an organic material or an inorganic material.

Moreover, since the outer surfaces of the pressure sensor elements 2 and their surrounding structures are covered with the pressure transmission medium 10 in the form of gel or liquid, the pressure sensor elements 2 and their surrounding structures can be protected.

As described above, since the pressure transmission medium 10 is in the form of liquid or gel and covers at least the pressure receiving surfaces 661, described later, of the pressure sensor elements 2 in the casing 4, it is possible to strengthen the protection of the pressure sensor elements 2 while enabling pressure transmission to the pressure receiving surfaces 661.

### Substrate

The substrate 3 has the functions of supporting the two pressure sensor elements 2 and electrically connecting the two pressure sensor elements 2. The substrate 3 is, for example, a printed wiring substrate, and includes a base material 31, a plurality of terminals 32 provided on the upper surface of the base material 31, a plurality of terminals 33 provided on the lower surface of the base material 31, wires 34 that penetrate the base material 31 to connect the terminals 32 and 33 with each other, and a plurality of terminals 35 provided on the upper surface of the base material 31.

The base material 31 is not particularly limited, but, for example, a base material impregnated with resin can be used similarly to a base material of a typical printed substrate.

The plurality of terminals 32 are connected to the pressure sensor element 2 (2a) via bonding materials 51 such as metal bumps or conductive adhesives. Similarly, the plurality of terminals 33 are connected to the pressure sensor element 2 (2b) via bonding materials 51 such as metal bumps or conductive adhesives. The plurality of terminals 32 and 33 are electrically connected to the wires 34 and not-shown wires so that piezoresistive elements 7 of the two pressure sensor elements 2 constitute a bridge circuit 70 as will be described later (see FIG. 4).

The plurality of terminals 35 are electrically connected to the bridge circuit 70 via the not-shown wires, and also connected to the above-described internal terminals (not shown) of the casing 4 via wires 53 composed of, for example, bonding wires. Due to this, the substrate 3 is electrically connected to the internal terminals of the casing 4 via the wires 53, and supported to the casing 4.

### Pressure Sensor Element

The two pressure sensor elements 2 include the pressure sensor element 2a provided on the upper surface side of the substrate 3 and the pressure sensor element 2b provided on the lower surface side of the substrate 3. In the embodiment, the pressure sensor element 2a and the pressure sensor element 2b are different in mounted position on the substrate 3, but have the same configuration.

Each of the pressure sensor elements 2 (2a and 2b) includes a substrate 6 and a stacked structure 8 provided on one of the major surfaces of the substrate 6. The substrate includes the diaphragm portion 66. A plurality of piezoresistive elements 7 are formed in the diaphragm portion 66. A portion of the stacked structure 8, which is disposed to face the diaphragm portion 66, is spaced from the substrate 6. Due to this, a cavity S (pressure reference chamber) is formed between the portion and the substrate 6.

Hereinafter, the parts constituting the pressure sensor element 2 will be successively described.

### Substrate 6

The substrate 6 includes a semiconductor substrate 61, an insulating film 62 provided on one of the major surfaces of the semiconductor substrate 61, an insulating film 63 provided on the insulating film 62 on the side opposite to the semiconductor substrate 61, and a conductor layer 64 provided on the insulating film 63 on the side opposite to the semiconductor substrate 61.

The semiconductor substrate 61 is an SOI substrate in which a silicon layer 611 (handle layer) made of single-crystal silicon, a silicon oxide layer 612 (BOX layer) made of a silicon oxide film, and a silicon layer 613 (device layer) made of single-crystal silicon are stacked in this order. The semiconductor substrate 61 is not limited to the SOI substrate, and may be any other semiconductor substrate such as, for example, a single-crystal silicon substrate.

The insulating film 62 is, for example, a silicon oxide film and has insulating properties. The insulating film 63 is, for example, a silicon nitride film, and has insulating properties and resistance to an etchant (etchant used in release etching) containing hydrofluoric acid. Here, since the insulating film 62 (silicon oxide film) lies between the semiconductor substrate 61 (the silicon layer 613) and the insulating film 63 (silicon nitride film), the transfer of stress generated in deposition of the insulating film 63 to the semiconductor substrate 61 can be reduced by the insulating film 62. Moreover, the insulating film 62 can be used as a device isolation film when a semiconductor circuit is formed on and above the semiconductor substrate 61. The insulating films 62 and 63 are not limited to the constituent materials descried above. Moreover, any one of the insulating films 62 and 63 may be omitted as necessary.

The semiconductor substrate 61 is provided with a bottomed recess 65 that is opened on the side opposite to the insulating films 62 and 63 and the conductor layer 64. Due to this, the substrate 6 is provided with the diaphragm portion 66, which is thinner than the surrounding portion thereof and is deflected and deformed under pressure. The lower surface of the diaphragm portion 66 is the pressure receiving surface 661. In the embodiment as shown in FIG. 3, the diaphragm portion 66 has a substantially square shape in a plan view.

In the substrate 6 of the embodiment, the recess 65 penetrates the silicon layer 611, and the diaphragm portion 66 includes four layers, the silicon oxide layer 612, the silicon layer 613, and the insulating films 62 and 63. Here, the silicon oxide layer 612 can be used as an etching stop layer in forming the recess 65 by etching in the manufacturing process of the pressure sensor element 2, so that product-by-product variations in the thickness of the diaphragm portion 66 can be reduced.

The recess 65 may not penetrate the silicon layer 611, and the diaphragm portion 66 may include five layers, a thin portion of the silicon layer 611, the silicon oxide layer 612, the silicon layer 613, and the insulating films 62 and 63.

The conductor layer 64 is configured by, for example, doping (diffusion or implantation) single-crystal silicon, polycrystalline silicon (polysilicon), or amorphous silicon with an impurity such as phosphorus or boron, and has conductivity. The conductor layer 64 has been patterned, and when, for example, a MOS transistor is formed on the substrate 6 outside the cavity S, a portion of the conductor layer 64 can be used as agate electrode of the MOS transistor. Moreover, a portion of the conductor layer 64 can be used as a wire. The conductor layer 64 is formed so as to surround the diaphragm portion 66 in the plan view, and thus forms a step portion corresponding to the thickness of the conductor layer 64. Due to this, when the diaphragm portion 66 is deflected and deformed under pressure, stress can be concentrated on a border portion of the diaphragm portion 66 relative to the step portion. Therefore, by disposing the piezoresistive elements 7 at the border portion (or near the border portion), detection sensitivity can be improved.

### Piezoresistive Element 7

As shown in FIG. 2, the plurality of piezoresistive elements 7 are formed on the cavity S side of the diaphragm portion 66 with respect to the center of the thickness of the silicon layer 611. Moreover, the plurality of piezoresistive elements 7 include piezoresistive elements 7a, 7b, 7c, and 7d disposed corresponding to four sides of the diaphragm portion 66 having a substantially quadrilateral shape in the plan view.

The piezoresistive element 7a includes a pair of piezoresistive areas that extend along a direction parallel to the corresponding side of the diaphragm portion 66 and are electrically connected in series. The piezoresistive element 7a is extracted to the outside by means of a pair of wires. Similarly, the piezoresistive element 7b includes a pair of piezoresistive areas that extend along a direction parallel to the corresponding side of the diaphragm portion 66 and are electrically connected in series. The piezoresistive element 7b is extracted to the outside by means of a pair of wires.

On the other hand, the piezoresistive element 7c includes a pair of piezoresistive areas that extend along a direction vertical to the corresponding side of the diaphragm portion 66 and are electrically connected in series. The piezoresistive element 7c is extracted to the outside by means of a pair of wires. Similarly, the piezoresistive element 7d includes a pair of piezoresistive areas that extend along a direction vertical to the corresponding side of the diaphragm portion 66 and are electrically connected in series. The piezoresistive element 7d is extracted to the outside by means of a pair of wires.

The piezoresistive elements 7a, 7b, 7c, and 7d and the wires are made of, for example, silicon (single-crystal silicon) doped (diffused or implanted) with an impurity such as phosphorus or boron. Here, the doping concentration of impurity in the wire is higher than the doping concentration of impurity in the piezoresistive elements 7a, 7b, 7c, and 7d. The wire may be made of metal.

The piezoresistive elements 7a, 7b, 7c, and 7d described above constitute the bridge circuit 70 (Wheatstone bridge circuit) as shown in FIG. 4. Here, the piezoresistive elements 7a, 7b, 7c, and 7d of the pressure sensor element 2a are paired in one-to-one correspondence with the piezoresistive elements 7a, 7b, 7c, and 7d of the pressure sensor element 2b, and the paired elements are connected in series via the substrate 3 described above. A driver circuit (not shown) that supplies a drive voltage AVDC is connected to the bridge circuit 70. The bridge circuit 70 outputs, as a detected signal, an output voltage Vₒᵤₜ in response to a change in the resistance value of the piezoresistive elements 7a, 7b, 7c, and 7d.

### Stacked Structure 8

The stacked structure 8 is formed so as to define the cavity S. The stacked structure 8 includes an inter-layer insulating film 81 formed on the substrate 6 so as to surround the piezoresistive elements 7 in the plan view, a wiring layer 82 formed on the inter-layer insulating film 81, an inter-layer insulating film 83 formed on the wiring layer 82 and the inter-layer insulating film 81, a wiring layer 84 formed on the inter-layer insulating film 83 and including a covering layer 841 including a plurality of fine pores 842 (openings), a surface protective film 85 formed on the wiring layer 84 and the inter-layer insulating film 83, and a sealing layer 86 provided on the covering layer 841.

Here, the wiring layers 82 and 84 have portions that are electrically connected to the piezoresistive elements 7. Moreover, the wiring layer 84 includes terminals 843 connected to the terminals 32 or the terminals 33 of the substrate 3 via the bonding materials 51.

As described above, since the stacked structure 8, which constitutes a portion of a wall portion of the cavity S, has a stacked structure, the stacked structure 8 can be formed using a semiconductor manufacturing process such as a CMOS process. Due to this, the pressure sensor 1 of small size can be manufactured easily and with high accuracy. Moreover, in forming the stacked structure 8, the cavity S can be formed by etching (sacrificial layer etching) through the fine pores 842. A semiconductor circuit may be fabricated on the silicon layer 613 on the side where the stacked structure 8 is disposed. The semiconductor circuit includes active elements, such as MOS transistors, and other circuit elements formed as necessary, such as capacitors, inductors, resistors, diodes, and wires (including the wires connected to the piezoresistive elements 7).

### Cavity S

The cavity S defined by the substrate 6 and the stacked structure 8 is a hermetically sealed space. The cavity S functions as a pressure reference chamber providing a reference value of the pressure that the pressure sensor element 2 detects. In the embodiment, the cavity S is in a vacuum state (300 Pa or less). By setting the cavity S into the vacuum state, the pressure sensor element 2 can be used as an “absolute pressure sensor” that detects pressure with the vacuum state as a reference, so that the convenience of the pressure sensor element 2 is improved. Here, the cavity S in one of the pressure sensor elements 2a and 2b constitutes a “first pressure reference chamber” including a wall portion a portion of which is configured of the diaphragm portion 66 (first diaphragm portion), while the cavity S in the other pressure sensor element constitutes a “second pressure reference chamber” including a wall portion a portion of which is configured of the diaphragm portion 66 (second diaphragm portion).

However, the cavity S may not be in the vacuum state. The cavity S may be in an atmospheric pressure state, a reduced-pressure state where the air pressure is lower than the atmospheric pressure, or a pressurized state where the air pressure is higher than the atmospheric pressure. Moreover, an inert gas such as nitrogen gas or noble gas may be sealed in the cavity S.

The configuration of the pressure sensor 1 has been briefly described above.

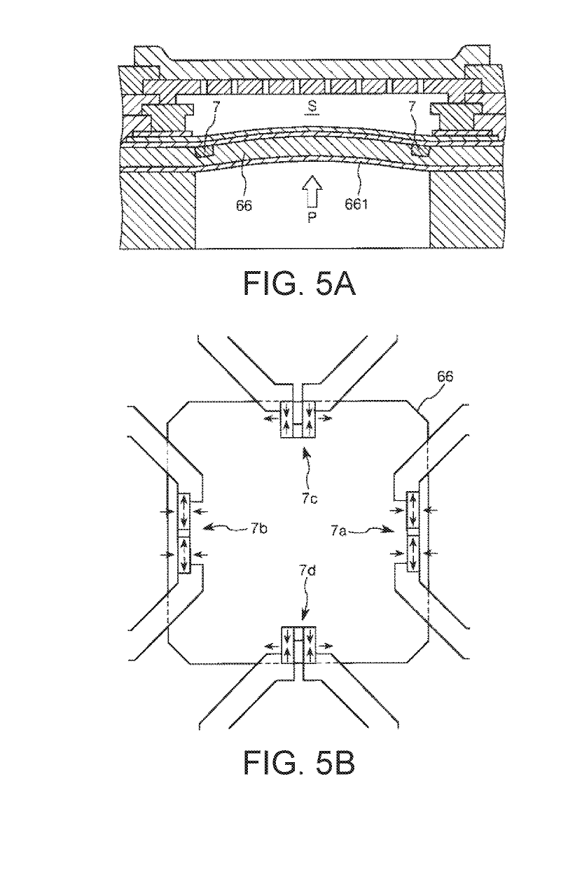

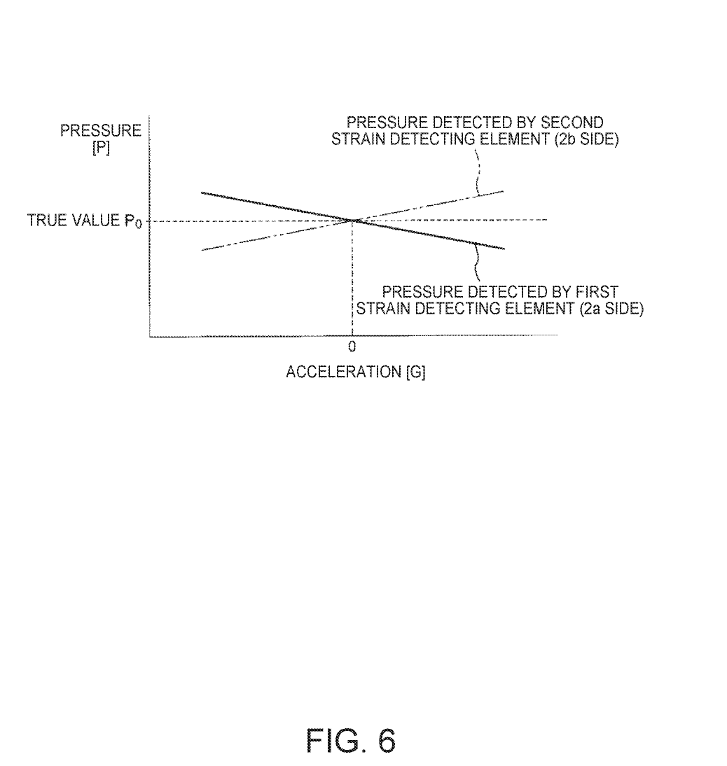

FIGS. 5A and 5B are diagrams for explaining the operation of the pressure sensor element shown in FIG. 2, in which FIG. 5A is a cross-sectional view showing a pressurized state and FIG. 5B is a plan view showing the pressurized state. FIG. 6 is a graph for explaining the operation of the pressure sensor shown in FIG. 1, showing the relationship between the acceleration applied to the pressure sensor and the detected pressure.

In each of the pressure sensor elements 2, as shown in FIG. 5A, the diaphragm portion 66 is deformed in response to pressure P received by the pressure receiving surface 661 of the diaphragm portion 66. Due to this, as shown in FIG. 5B, the piezoresistive elements 7a, 7b, 7c, and 7d are strained, so that the resistance values of the piezoresistive elements 7a, 7b, 7c, and 7d change. In association with the change, the output voltage Vₒᵤₜ of the bridge circuit 70 (see FIG. 4) including the piezoresistive elements 7a, 7b, 7c, and 7d changes, and based on the output voltage Vₒᵤₜ, the magnitude of the pressure P received by the pressure receiving surface 661 can be obtained.

Here, when the above-described deformation of the diaphragm portion 66 is caused, a compressive strain along the width direction of the piezoresistive elements 7a and 7b and a tensile strain along the longitudinal direction thereof are generated in the piezoresistive elements 7a and 7b while a tensile strain along the width direction of the piezoresistive elements 7c and 7d and a compressive strain along the longitudinal direction thereof are generated in the piezoresistive elements 7c and 7d as shown in FIG. 5B. Hence, when the above-described deformation of the diaphragm portion 66 is caused, one of the resistance value of the piezoresistive elements 7a and 7b and the resistance value of the piezoresistive elements 7c and 7d increases while the other resistance value decreases.

Acceleration such as gravitational acceleration is applied due to gravity, impact, or the like to the diaphragm portion 66 according to the posture of the diaphragm portion 66. Actually, therefore, the amount of deflection deformation of the diaphragm portion 66 may be different from that caused by the pressure applied to the diaphragm portion 66.

In the pressure sensor 1, therefore, the pressure receiving surface 661 of the diaphragm portion 66 of the pressure sensor element 2a and the pressure receiving surface 661 of the diaphragm portion 66 of the pressure sensor element 2b are arranged to be opposed to each other (oriented in different directions) as described above. Due to this, the variation amounts of the output of the piezoresistive elements 7 of the pressure sensor element 2a and the output of the piezoresistive elements 7 of the pressure sensor element 2b generated when acceleration such as gravitational acceleration acts on the pressure sensor 1 can be canceled out each other or reduced. Therefore, the influence of acceleration such as gravitational acceleration is reduced, and thus the pressure can be detected with high accuracy.

Specifically, when a downward acceleration G is applied to the diaphragm portion 66 as shown in FIG. 2, the amount of strain of the piezoresistive elements 7 of the pressure sensor element 2a is greater than the amount of strain caused only by the pressure by an amount corresponding to the acceleration G while the amount of strain of the piezoresistive elements 7 of the pressure sensor element 2b is smaller than the amount of strain caused only by the pressure by the amount corresponding to the acceleration G. Conversely, when an upward acceleration G is applied to the diaphragm portion 66, the amount of strain of the piezoresistive elements 7 of the pressure sensor element 2a is smaller than the amount of strain caused only by the pressure by an amount corresponding to the acceleration G while the amount of strain of the piezoresistive elements 7 of the pressure sensor element 2b is greater than the amount of strain caused only by the pressure by the amount corresponding to the acceleration G.

Hence, when the acceleration G acts in the up-and-down direction (the thickness direction of the diaphragm portion 66) on the diaphragm portions 66 of the pressure sensor elements 2a and 2b, the detected pressure based only on the piezoresistive elements 7 of the pressure sensor element 2a is smaller than an actual pressure (true value P₀) as the downward acceleration G becomes greater as shown in FIG. 6, while the detected pressure based only on the piezoresistive elements 7 of the pressure sensor element 2b is greater than the actual pressure (true value P₀). Conversely, the detected pressure based only on the piezoresistive elements 7 of the pressure sensor element 2a is greater than the actual pressure (true value P₀) as the downward acceleration G becomes smaller, while the detected pressure based only on the piezoresistive elements 7 of the pressure sensor element 2b is smaller than the actual pressure (true value P₀).

From the facts described above, the variation amounts of the output of the piezoresistive elements 7 of the pressure sensor element 2a and the output of the piezoresistive elements 7 of the pressure sensor element 2b generated when acceleration such as gravitational acceleration acts on the pressure sensor 1 can be canceled out each other or reduced in the pressure sensor 1. Therefore, the influence of acceleration such as gravitational acceleration is reduced, and thus the pressure can be detected with high accuracy.

Furthermore, the piezoresistive elements 7 of the pressure sensor element 2a and the piezoresistive elements 7 of the pressure sensor element 2b have portions that are connected in series. Due to this, one signal in which the above-described influence of acceleration such as gravitational acceleration is reduced can be output from the pressure sensor 1. In connecting, in series, the respective piezoresistive elements 7 of the pressure sensor element 2a and the pressure sensor element 2b, the piezoresistive elements 7 whose resistance values increase together, or decrease together, under the pressure P with no application of the acceleration G are selected. That is, the piezoresistive elements 7 whose voltages as output signals therefrom increase together, or decrease together, are selected, and connected in series to each other. Moreover, by connecting one or more sets of the piezoresistive elements 7 whose resistance values increase together, or decrease together, to each other, the pressure can be measured with higher accuracy. Further, by connecting two or more sets of the piezoresistive elements 7 whose resistance values increase together, or decrease together, to each other to constitute the bridge circuit 70, the pressure can be measured with still higher accuracy. Therefore, compared with the case where the respective signals of the piezoresistive elements 7 of the pressure sensor element 2a and the piezoresistive elements 7 of the pressure sensor element 2b are output from the pressure sensor 1, the circuit configuration in the pressure sensor 1 is simplified, and as a result, the power saving of the pressure sensor 1 can be achieved.

Especially, in one bridge circuit 70 configured to include the piezoresistive elements 7 of the pressure sensor element 2a and the piezoresistive elements 7 of the pressure sensor element 2b, the variation amounts of the output of the piezoresistive elements 7 of the pressure sensor element 2a and the output of the piezoresistive elements 7 of the pressure sensor element 2b generated when acceleration such as gravitational acceleration acts on the pressure sensor 1 can be canceled out each other or reduced. Due to this, one signal in which the influence of acceleration such as gravitational acceleration is reduced can be output from the bridge circuit 70.

Here, in one of the pressure sensor element 2a and the pressure sensor element 2b, the pressure receiving surface 661 includes a “first pressure receiving surface”; the diaphragm portion 66 includes the “first diaphragm portion” deflected and deformed under the pressure received by the pressure receiving surface 661; and the piezoresistive element 7 includes a “first strain detecting element” disposed in the diaphragm portion 66 and outputting a signal in response to a strain. On the other hand, in the other pressure sensor element, the pressure receiving surface 661 includes a “second pressure receiving surface”; the diaphragm portion 66 includes the “second diaphragm portion” deflected and deformed under the pressure received by the pressure receiving surface 661; and the piezoresistive element 7 includes a “second strain detecting element” electrically connected to the piezoresistive element 7 of the one pressure sensor element, disposed in the diaphragm portion 66, and outputting a signal in response to a strain.

Moreover, in the embodiment, since the pressure sensor element 2a and the pressure sensor element 2b are both supported by the substrate 3, the pressure receiving surfaces 661 of both the pressure sensor elements 2a and 2b can be stably held in desired orientations. Moreover, the piezoresistive elements 7 of the pressure sensor element 2a and the piezoresistive elements 7 of the pressure sensor element 2b can be electrically connected via the substrate 3. Then, one signal in which the influence of acceleration such as gravitational acceleration is reduced can be output from the substrate 3. Here, one of the pressure sensor element 2a and the pressure sensor element 2b constitutes a “first structure” including the diaphragm portion 66 (first diaphragm portion) while the other pressure sensor element constitutes a “second structure” including the diaphragm portion 66 (second diaphragm portion).

Moreover, the pressure sensor element 2a is disposed on one surface side of the substrate 3, and the pressure sensor element 2b is disposed on the other surface side of the substrate 3. Therefore, it becomes easy to install the pressure sensor elements 2a and 2b on the substrate 3 such that the respective pressure receiving surfaces 661 are opposed to each other.

### Second Embodiment

Next, a second embodiment of a pressure sensor according to the invention will be described.

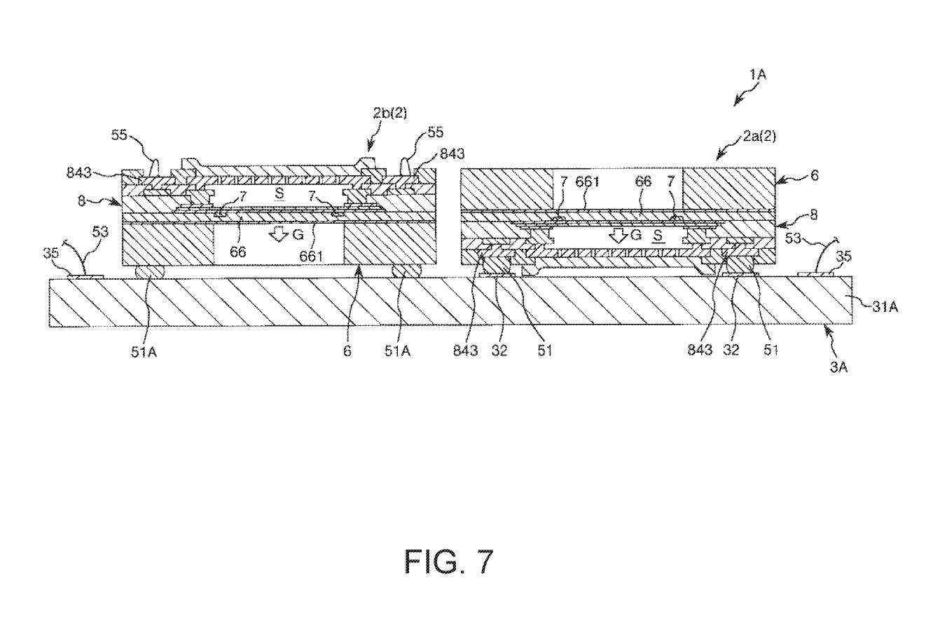

FIG. 7 is a cross-sectional view showing a main portion of the pressure sensor according to the second embodiment of the invention.

Hereinafter, the second embodiment of the pressure sensor according to the invention will be described, in which differences from the embodiment described above are mainly described and a description of similar matters is omitted. In FIG. 7, configurations similar to the embodiment described above are denoted by the same reference numerals and signs.

The second embodiment is similar to the first embodiment described above, except that two pressure sensor elements are disposed on one surface of a substrate.

The pressure sensor 1A shown in FIG. 7 includes the two pressure sensor elements 2 and a substrate 3A that supports the two pressure sensor elements 2.

The substrate 3A includes a base material 31A, and the plurality of terminals 32 and the plurality of terminals 35 provided on the upper surface of the base material 31A.

Similarly to the first embodiment described above, the plurality of terminals 32 are connected to the pressure sensor element 2a via the bonding materials 51. In the embodiment, the pressure sensor element 2b is bonded to the upper surface of the substrate 3A via bonding materials 51A composed of adhesives or the like. Here, the pressure sensor element 2b is installed such that the pressure receiving surface 661 faces downward, and a gap is formed between the pressure sensor element 2b and the substrate 3A due to the bonding materials 51A. Due to this, the pressure receiving surface 661 of the pressure sensor element 2b can receive pressure.

Moreover, the terminals 843 of the pressure sensor element 2b are electrically connected, via wires 55 composed of bonding wires, to terminals (not shown) provided on the upper surface of the substrate 3A. Due to this, the piezoresistive elements 7 of the pressure sensor element 2b have portions that are connected in series to the piezoresistive elements 7 of the pressure sensor element 2a via the substrate 3A, and thus constitute a bridge circuit similar to that of the first embodiment described above.

As described above, since the pressure sensor element 2a and the pressure sensor element 2b are both disposed on one surface side of the substrate 3A, the low profile of the pressure sensor 1A can be achieved.

The pressure sensor 1A described above also can provide excellent detection accuracy while achieving power saving.

### Third Embodiment

Next, a third embodiment of a pressure sensor according to the invention will be described.

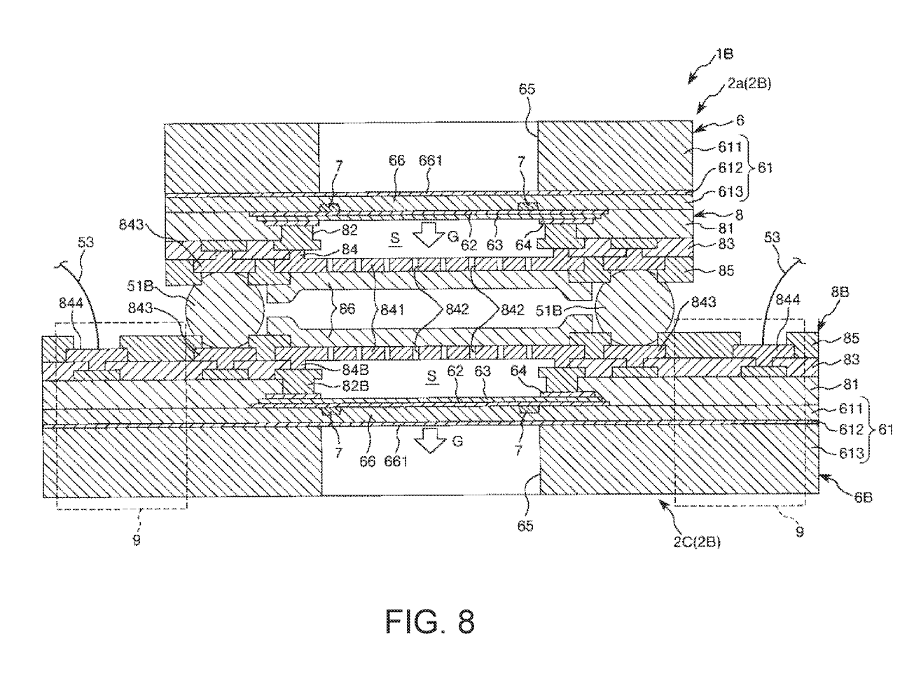

FIG. 8 is a cross-sectional view showing a main portion of the pressure sensor according to the third embodiment of the invention.

Hereinafter, the third embodiment of the pressure sensor according to the invention will be described, in which differences from the embodiments described above are mainly described and a description of similar matters is omitted. In FIG. 8, configurations similar to the embodiments described above are denoted by the same reference numerals and signs.

The third embodiment is similar to the first embodiment described above, except that two pressure sensor elements are different in size from each other, and that a substrate between the two pressure sensor elements is omitted.

The pressure sensor 1B shown in FIG. 8 includes two pressure sensor elements 2B bonded together via conductive bonding materials 51B. Here, the two pressure sensor elements 2B include the pressure sensor element 2a and a pressure sensor element 2c bonded to the pressure sensor element 2a via the conductive bonding materials 51B. As described above, the pressure sensor element 2a and the pressure sensor element 2c are bonded together without a substrate in the embodiment. Due to this, the miniaturization of the entire structure including the pressure sensor elements 2a and 2c can be achieved.

The pressure sensor element 2c includes a substrate 6B including the diaphragm portion 66, and a stacked structure 8B provided on the upper surface of the substrate 6B. The stacked structure 8B includes the inter-layer insulating film formed on the substrate 6B so as to surround the piezoresistive elements 7 in the plan view, a wiring layer 82B formed on the inter-layer insulating film 81, the inter-layer insulating film 83 formed on the wiring layer 82B and the inter-layer insulating film 81, a wiring layer 84B formed on the inter-layer insulating film 83 and including the covering layer 841 including the plurality of fine pores (openings), the surface protective film 85 formed on the wiring layer 84B and the inter-layer insulating film 83, and the sealing layer 86 provided on the covering layer 841.

The wiring layer 84B includes the terminals 843 bonded to the terminals 843 of the pressure sensor element 2a via the bonding materials 51B. Due to this, the pressure sensor element 2c is electrically connected to the pressure sensor element 2a. The wiring layer 82B and the wiring layer 84B are configured so as to form a bridge circuit similar to that of the first embodiment described above.

Moreover, the wiring layer 84B includes terminals 844 connected to the wires 53. Here, the pressure sensor element 2c includes a portion having a width greater than that of the pressure sensor element 2a and protruding from the pressure sensor element 2a in the plan view. At the portion, the terminals 844 are provided. Due to this, the connection to the casing 4 via the wires 53 can be made easy.

Moreover, a circuit portion 9 is provided on the outer peripheral portion side of the pressure sensor element 2c in the embodiment. Due to this, the circuit portion 9 can be disposed by effectively using the above-described protruding portion of the pressure sensor element 2c. The circuit portion 9 can include, for example, a driver circuit for supplying a voltage to the bridge circuit, a temperature compensation circuit for temperature-compensating the output from the bridge circuit, a pressure detecting circuit that obtains the applied pressure from the output from the temperature compensation circuit, and an output circuit that converts the output from the pressure detecting circuit into an output in a predetermined output format (CMOS, LV-PECL, LVDS, etc.), and outputs the output.

The pressure sensor 1B described above also can provide excellent detection accuracy while achieving power saving.

### Fourth Embodiment

Next, a fourth embodiment of a pressure sensor according to the invention will be described.

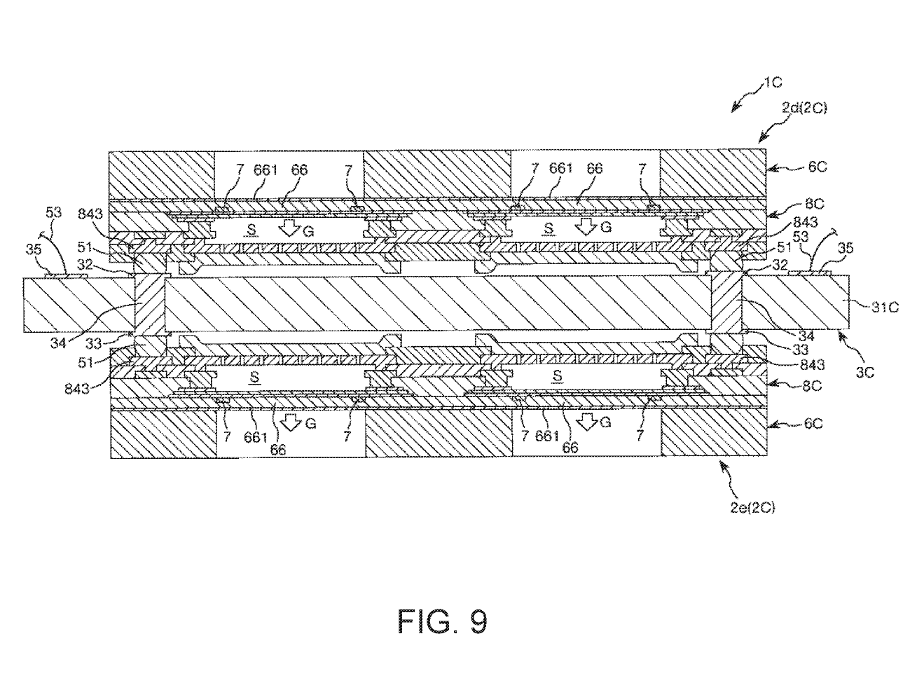

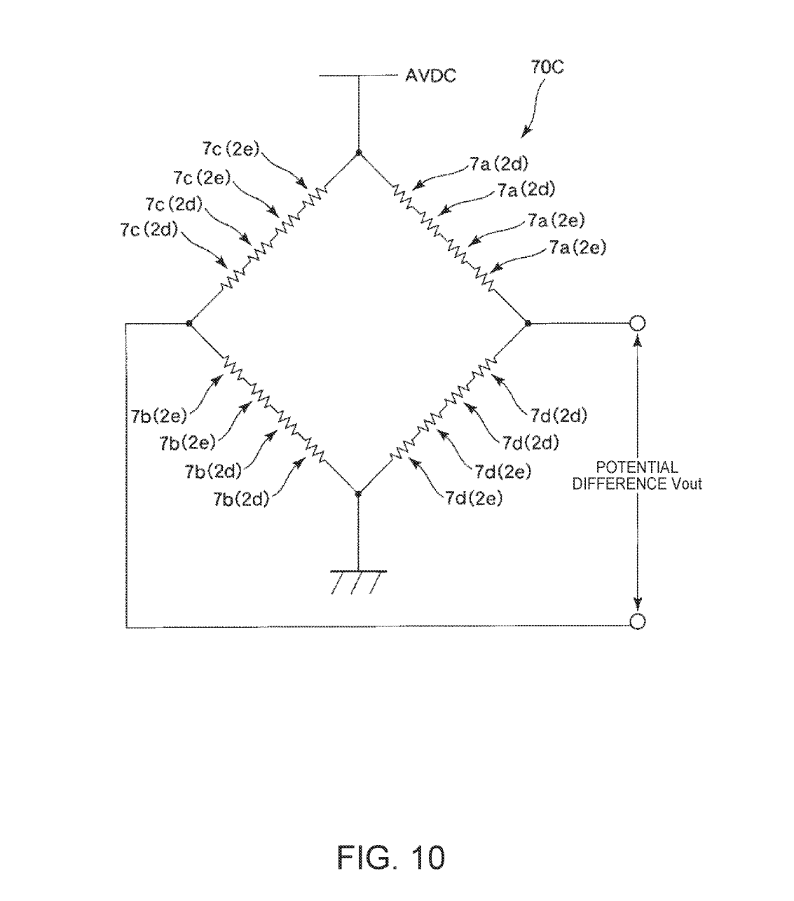

FIG. 9 is a cross-sectional view showing a main portion of the pressure sensor according to the fourth embodiment of the invention. FIG. 10 is a diagram showing a circuit including piezoresistive elements of pressure sensor elements shown in FIG. 9.

Hereinafter, the fourth embodiment of the pressure sensor according to the invention will be described, in which differences from the embodiments described above are mainly described and a description of similar matters is omitted. In FIGS. 9 and 10, configurations similar to the embodiments described above are denoted by the same reference numerals and signs.

The fourth embodiment is similar to the first embodiment described above, except that each of pressure sensor elements includes a plurality of diaphragm portions.

The pressure sensor 1C shown in FIG. 9 includes two pressure sensor elements 2C and a substrate 3C that supports the two pressure sensor elements 2C.

The two pressure sensor elements 2C include a pressure sensor element 2d provided on the upper surface side of the substrate 3C and a pressure sensor element 2e provided on the lower surface side of the substrate 3C. In the embodiment, the pressure sensor element 2d and the pressure sensor element 2e are different in mounted position on the substrate 3C, but have the same configuration.

Each of the pressure sensor elements 2C includes a plurality of (in the embodiment, two) diaphragm portions 66 and a plurality of cavities S corresponding thereto. The number of the diaphragm portions 66 included in each of the pressure sensor elements 2C is not limited to that described above, but may be three or more. Moreover, the cavity S may correspond to two or more diaphragm portions, or may be in communication with another cavity S.

The substrate 3C includes a base material 31C, the plurality of terminals 32 provided on the upper surface of the base material 31C, the plurality of terminals 33 provided on the lower surface of the base material 31C, the wires 34 penetrating the base material 31C to connect the terminals 32 and 33 with each other, and the plurality of terminals 35 provided on the upper surface of the base material 31C. Due to this, the two pressure sensor elements 2C are electrically connected via the substrate 3C so as to constitute a bridge circuit 70C shown in FIG. 10.

As described above, since each of the pressure sensor elements 2C includes the plurality of diaphragm portions 66, the S/N ratio can be improved.

The pressure sensor 10 described above also can provide excellent detection accuracy while achieving power saving.

### Fifth Embodiment

Next, a fifth embodiment of a pressure sensor according to the invention will be described.

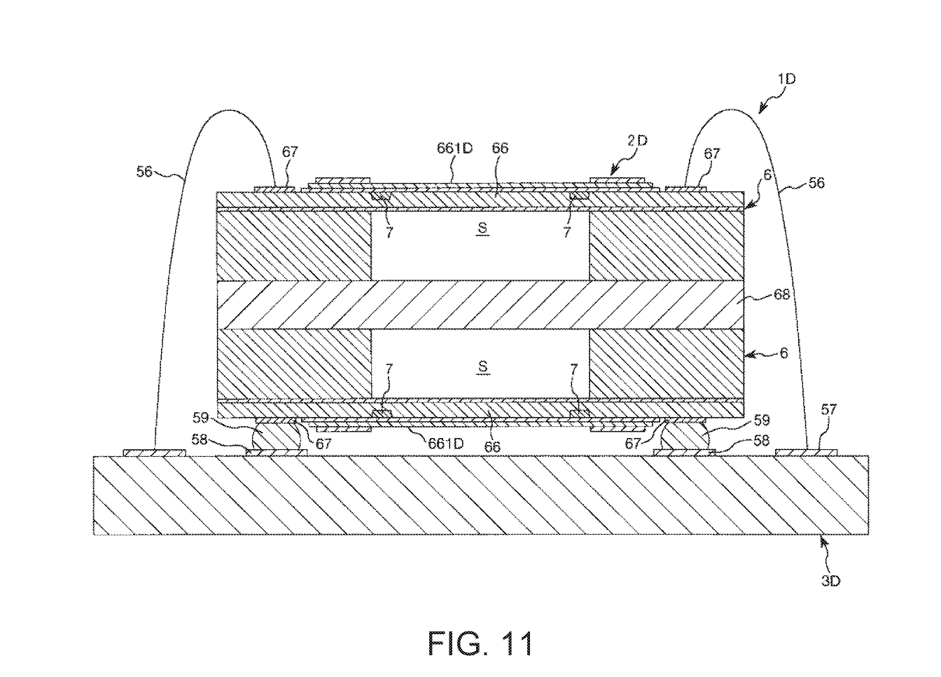

FIG. 11 is a cross-sectional view showing a main portion of the pressure sensor according to the fifth embodiment of the invention.

Hereinafter, the fifth embodiment of the pressure sensor according to the invention will be described, in which differences from the embodiments described above are mainly described and a description of similar matters is omitted. In FIG. 11, configurations similar to the embodiments described above are denoted by the same reference numerals and signs.

The fifth embodiment is similar to the first embodiment described above, except that a pressure reference chamber is configured by attaching substrates.

The pressure sensor 1D shown in FIG. 11 includes a pressure sensor element 2D and a substrate 3D that supports the pressure sensor element 2D. The pressure sensor element 2D includes two substrates 6 including the diaphragm portions 66, and the surfaces of the two substrates 6 on the handle layer sides are bonded together via a substrate 68.

In the pressure sensor element 2D, recesses of the substrates 6 are closed by the substrate 68 to thereby constitute the cavities S functioning as pressure reference chambers. The substrate 68 is not particularly limited, but, for example, a silicon substrate, a glass substrate, or the like can be used. Moreover, the method of bonding the substrate 68 with the substrates 6 is not particularly limited. However, when, for example, the substrate 68 is a silicon substrate, a direct bonding method can be used; while when the substrate 68 is a glass substrate, an anodic bonding method can be used.

The surface of the diaphragm portion 66 on the side opposite to the substrate 68, the diaphragm portion 66 being included in each of the substrates 6, constitutes a pressure receiving surface 661D. Here, the pressure receiving surfaces 661D of the two diaphragm portions 66 are opposed to each other. One of the pressure receiving surfaces 661D constitutes the “first pressure receiving surface”, and the other pressure receiving surface 661D constitutes the “second pressure receiving surface”. The diaphragm portion 66 including the one pressure receiving surface 661D constitutes the “first diaphragm portion”, and the diaphragm portion 66 including the other pressure receiving surface 661D constitutes the “second diaphragm portion”.

Moreover, in the embodiment, a plurality of terminals 67 are provided on the surface of the substrate 6 on the side opposite to the substrate 68. The terminals 67 of one (on the lower side with respect to the substrate 68 in FIG. 11) of the two substrates 6 are connected via conductive bonding materials 59 to terminals 58 included in the substrate 3D. The terminals 67 of the other (on the upper side with respect to the substrate 68 in FIG. 11) of the two substrates 6 are electrically connected, via wires 56 composed of bonding wires, to terminals 57 included in the substrate 3D. Due to this, the pressure sensor element 2D and the substrate 3D are electrically connected to each other so as to form a bridge circuit similarly to the first embodiment described above.

The pressure sensor element 2D makes it possible to provide the pressure receiving surfaces 661D opposed to each other in one element. Therefore, the configuration of the pressure sensor 1D can be simplified.

The pressure sensor 1D described above also can provide excellent detection accuracy while achieving power saving.

### Modified Example

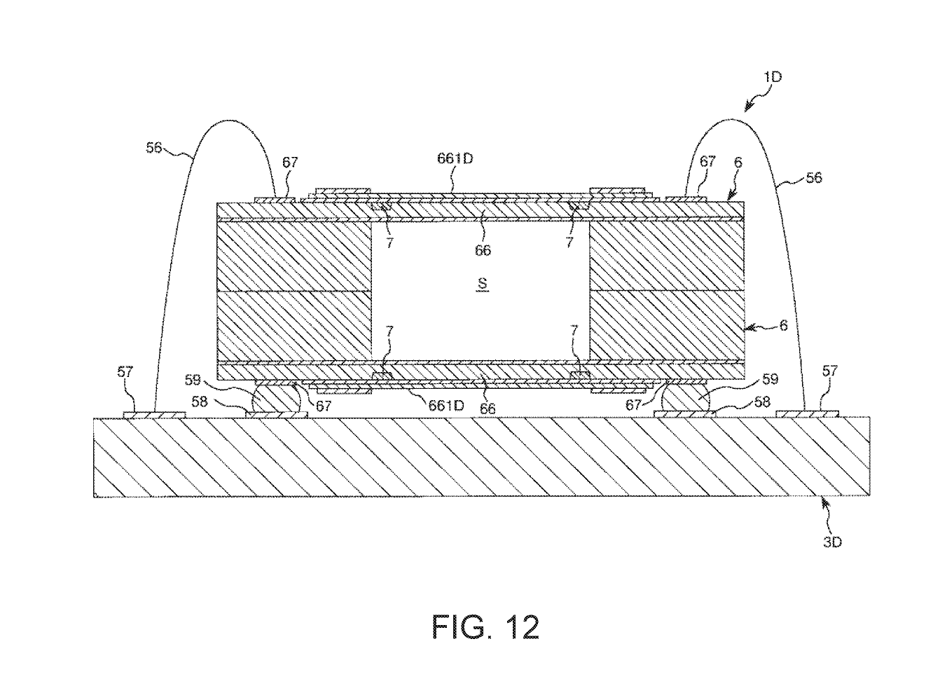

FIG. 12 is a cross-sectional view showing a modified example of the main portion shown in FIG. 11.

In the pressure sensor 1D described above, the two substrates 6 may be directly bonded together with the omission of the substrate 68 as shown in FIG. 12. In this case, the recess of one of the substrates 6 and the recess of the other substrate 6 are closed together to form the cavity S (pressure reference chamber). In other words, two pressure reference chambers (the first pressure reference chamber and the second pressure reference chamber) are in communication with each other. Due to this, the pressure in the first pressure reference chamber and the pressure in the second pressure reference chamber can be easily equal to each other, and one diaphragm portion 66 (first diaphragm portion) and the other diaphragm portion 66 (second diaphragm portion) can be deflected and deformed with the common pressure as a reference. Therefore, the pressure sensor can be easily designed or manufactured.

### Sixth Embodiment

Next, a sixth embodiment of a pressure sensor according to the invention will be described.

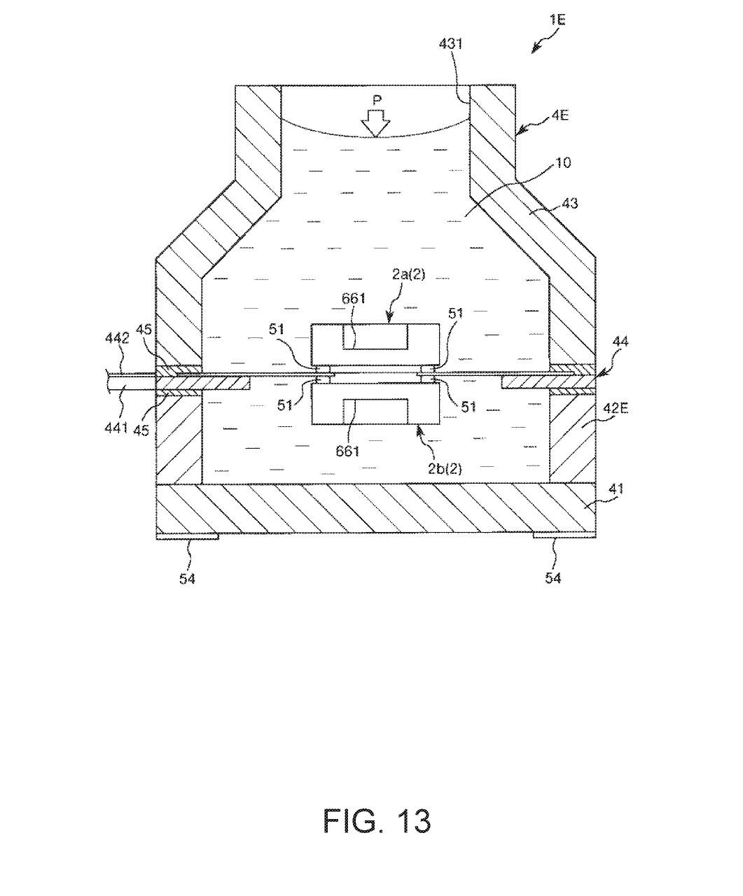

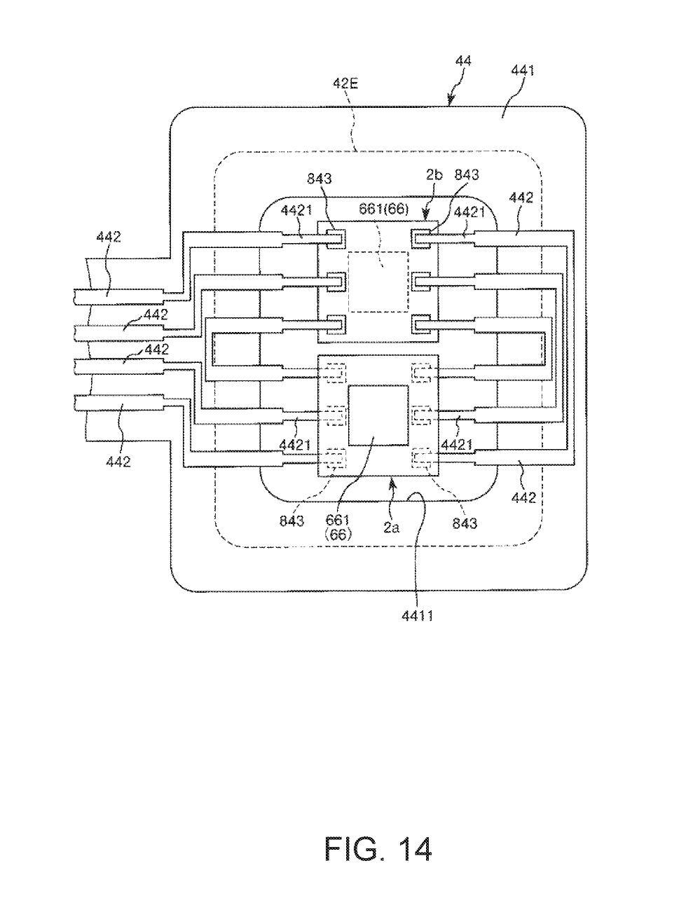

FIG. 13 is a cross-sectional view showing the pressure sensor according to the sixth embodiment of the invention. FIG. 14 is a plan view showing a main portion of the pressure sensor shown in FIG. 13.

Hereinafter, the sixth embodiment of the pressure sensor according to the invention will be described, in which differences from the embodiments described above are mainly described and a description of similar matters is omitted. In FIGS. 13 and 14, configurations similar to the embodiments described above are denoted by the same reference numerals and signs.

The sixth embodiment is similar to the first embodiment described above, except that a flexible wiring substrate is used to support two pressure sensor elements.

The pressure sensor 1E shown in FIG. 13 includes the two pressure sensor elements 2 (2a and 2b), a casing 4E (container) that accommodates the two pressure sensor elements 2, and the pressure transmission medium 10 filled in the casing 4E.

The casing 4E includes the plate-like base 41, a frame-like frame body 42E bonded to one of the surfaces of the base 41, a flexible wiring substrate 44 (FPC: Flexible Printed Circuits) bonded to the surface of the frame body 42E on the side opposite to the base 41, and the tubular cylindrical body 43 bonded to the surface of the flexible wiring substrate 44 on the side opposite to the frame body 42E. Here, the flexible wiring substrate 44 is provided so as to be interposed between the frame body 42E and the cylindrical body 43, and is bonded to the frame body 42E and the cylindrical body 43 with an adhesive 45.

The flexible wiring substrate 44 has the functions of supporting the two pressure sensor elements 2 in the casing 4E, and constituting a bridge circuit together with the two pressure sensor elements 2 and extracting an electric signal from the bridge circuit to the outside of the casing 4E. The flexible wiring substrate 44 includes a flexible base material 441 and a plurality of wires 442 formed on the upper surface side of the base material 441.

As shown in FIG. 14, the base material 441 includes an opening 4411 in the central portion in a plan view. The base material 441 includes a portion that is extracted from within the casing 4E to the outside of the casing 4E. The constituent material of the base material 441 is not particularly limited as long as the base material 441 can have flexibility and insulating properties. Examples of the constituent material include, for example, polyimide, polyethylene terephthalate (PET), polyethylene naphthalate (PEN), and polyethersulfone (PES), and one kind or two or more kinds of these materials can be used in combination.

A portion of each of the wires 442 is a flying lead 4421 that protrudes from the base material 441 to the opening 4411 side. The tip end portion of the flying lead 4421 is connected to the terminal 843 of the pressure sensor element 2 via a not-shown conductive bonding material (e.g., a metal brazing material such as solder, a metal bump such as a gold bump, a conductive adhesive, etc.). Due to this, the pressure sensor elements 2 are supported to the flexible wiring substrate 44, and electrically connected to the flexible wiring substrate 44. Here, the pressure sensor element 2a and the pressure sensor element 2b are disposed such that the pressure receiving surfaces 661 are opposed to each other.

Moreover, the plurality of wires 442 are configured so as to form a bridge circuit together with the pressure sensor elements 2a and 2b. Four of the plurality of wires 442 are extracted on the base material 441 to the outside of the casing 4E for inputting a drive voltage to the bridge circuit and extracting an output signal. The constituent material of the wire 442 is not particularly limited as long as the material has conductivity. Examples of the constituent material include, for example, metal such as Ni, Pt, Li, Mg, Sr, Ag, Cu, Co, or Al, an alloy containing the metal such as MgAg, AlLi, or CuLi, and an oxide such as ITO or SnO₂, and one kind or two or more kinds of these materials can be used in combination.

The number, arrangement, and the like of the wires 442 are not limited to those shown in the drawing, and can be appropriately set according to the wire structure and the like in each of the pressure sensor elements 2.

As described above, by disposing the pressure sensor elements 2a and 2b on the flexible wiring substrate 44, the action of external stress on the pressure sensor elements 2a and 2b can be reduced. As a result, the detection accuracy can be improved.

The pressure sensor 1E described above also can provide excellent detection accuracy while achieving power saving.

### 2. Portable Apparatus

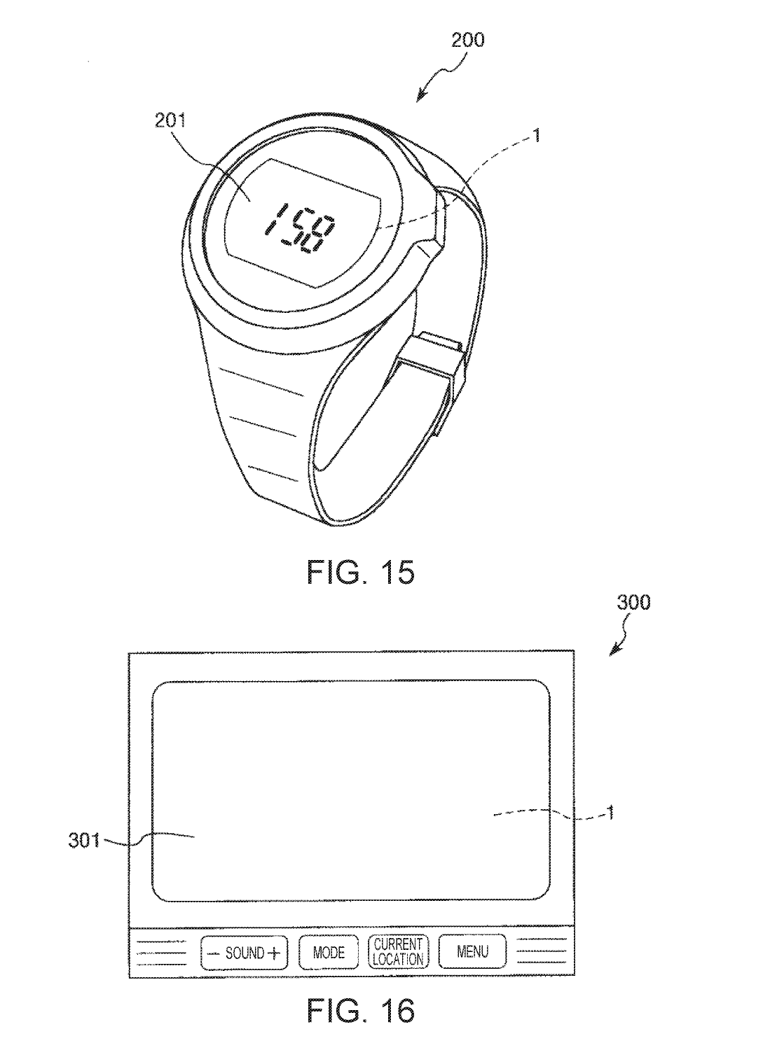

Next, an example of a portable apparatus (portable apparatus according to the invention) including the pressure sensor according to the invention will be described. FIG. 15 is a perspective view showing the example of the portable apparatus according to the invention.

The portable apparatus 200 is a wristwatch-type portable apparatus that can be worn on the wrist of a user. The pressure sensor 1 is mounted in the interior of the portable apparatus 200, so that the altitude of a current location above sea level, the air pressure of a current location, and the like can be displayed on a display portion 201 using the detected pressure of the pressure sensor 1.

In addition to the above, various information such as a current time, the heart rate of the user, and weather can be displayed on the display portion 201.

According to the portable apparatus 200, the pressure sensor 1 reduces the influence of acceleration such as gravitational acceleration, and thus can detect the pressure with high accuracy, irrespective of the usage conditions of the user (e.g., the posture of the portable apparatus 200), the mounting orientation of the pressure sensor 1, or the like. Moreover, since the pressure sensor 1 is power-saving, the miniaturization of the portable apparatus 200 can be achieved, or the design flexibility of the portable apparatus 200 can be increased.

The portable apparatus according to the invention is not limited to that of the wristwatch-type described above, and can be applied to various types of portable apparatuses such as a smartphone, a mobile phone, and a head-mounted display.

### 3. Electronic Apparatus

Next, a navigation system to which an electronic apparatus including the pressure sensor according to the invention is applied will be described. FIG. 16 is an elevation view showing an example of the electronic apparatus according to the invention.

A navigation system 300 includes map information (not shown), a position information acquiring unit that acquires position information from a global positioning system (GPS), a self-contained navigation unit using a gyro sensor, an acceleration sensor, and vehicle speed data, the pressure sensor 1, and a display portion 301 that displays predetermined position information or route information.

According to the navigation system, altitude information can be acquired in addition to acquired position information. For example, when a car runs on an elevated road indicated on the position information at substantially the same position as an open road, the navigation system cannot determine, in the absence of altitude information, whether the car runs on the open road or the elevated road, and therefore, the navigation system provides the user with information on the open road as preferential information. In the navigation system 300 according to the embodiment, altitude information can be acquired by the pressure sensor 1, a change in altitude due to the car entering the elevated road from the open road is detected, and thus it is possible to provide the user with navigation information in a running state on the elevated road.

Especially, in the navigation system 300, the pressure sensor 1 is power-saving, reduces the influence of acceleration such as gravitational acceleration, and thus can detect the pressure with high accuracy.

The display portion 301 is composed of, for example, a liquid crystal panel display or an organic electro-luminescence (EL) display, so that reductions in size and thickness are possible.

The electronic apparatus including the pressure sensor according to the invention is not limited to that described above, and can be applied to, for example, a personal computer, a mobile phone, a medical apparatus (e.g., an electronic thermometer, a sphygmomanometer, a blood glucose meter, an electrocardiogram measuring system, an ultrasonic diagnosis apparatus, and an electronic endoscope), various types of measuring instrument, indicators (e.g., indicators used in a vehicle, aircraft, and a ship), and a flight simulator.

### 4. Moving Object

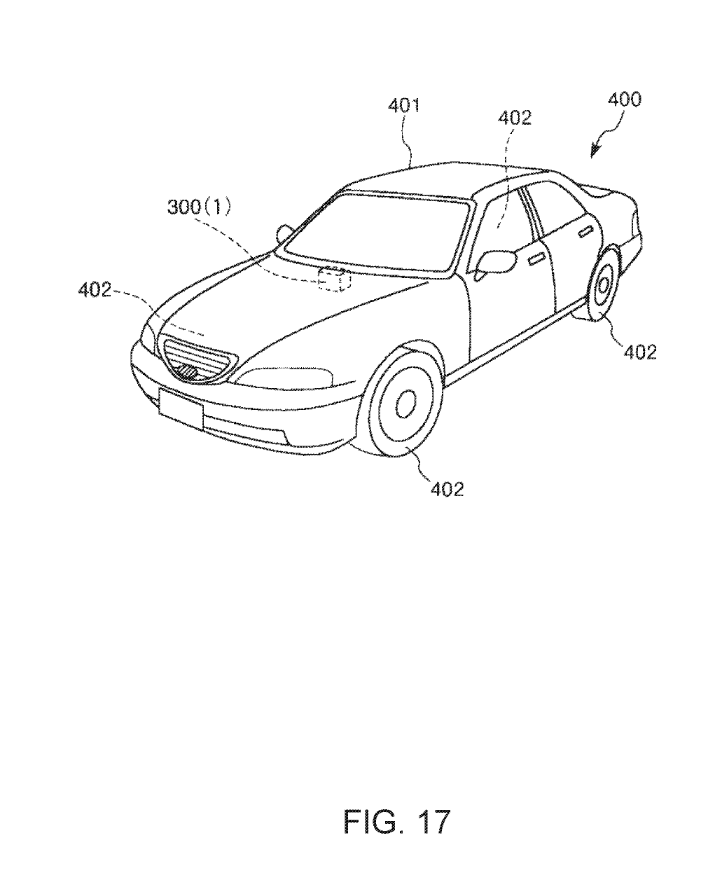

Next, a moving object (moving object according to the invention) to which the pressure sensor according to the invention is applied will be described. FIG. 17 is a perspective view showing an example of the moving object according to the invention.

As shown in FIG. 17, a moving object 400 includes a car body 401 and four wheels 402, and is configured to rotate the wheels 402 with a not-shown source of power (engine) provided in the car body 401. Into the moving object 400, the navigation system 300 (the pressure sensor 1) is incorporated.

According to the moving object 400, the pressure sensor 1 is power-saving, reduces the influence of acceleration such as gravitational acceleration, and thus can detect the pressure with high accuracy.

The pressure sensor, the portable apparatus, the electronic apparatus, and the moving object according to the invention have been described above based on the embodiments shown in the drawings, but the invention is not limited to the embodiments. The configuration of each part can be replaced with any configuration having a similar function. Moreover, any other components or steps may be added.

Moreover, in the embodiments described above, the number of piezoresistive elements (strain detecting elements) provided in one diaphragm portion is not limited to that of the embodiments described above, and may be from one to three, or five or more. The piezoresistive elements provided at each place of the diaphragm portion may not be two piezoresistive elements that are connected in series, and one piezoresistive element may be provided at each place. Moreover, the arrangement, shape, and the like of the piezoresistive elements are not limited to those of the embodiments described above. For example, the piezoresistive element may be disposed in the central portion of the diaphragm portion in the embodiments described above.

Moreover, in the embodiments described above, an example in which the first pressure receiving surface and the second pressure receiving surface are directly opposed to each other has been described. However, as long as the orientations of the first pressure receiving surface and the second pressure receiving surface include components that are opposed to each other, the variation amounts of the output of the first strain detecting element and the output of the second strain detecting element generated when acceleration such as gravitational acceleration acts on the pressure sensor can be canceled out each other or reduced. In this case, it is sufficient that a design is made in consideration of a mutual inclination angle of the first pressure receiving surface and the second pressure receiving surface. In this case, if a circuit used for corrections becomes necessary, a relatively simple one suffices.

Moreover, in the embodiments described above, an example in which the first diaphragm portion and the second diaphragm portion have the same configuration has been described. However, even when the first diaphragm portion and the second diaphragm portion have configurations different from each other, the variation amounts of the output of the first strain detecting element and the output of the second strain detecting element generated when acceleration such as gravitational acceleration acts on the pressure sensor can be canceled out each other or reduced. In this case, it is sufficient that a design is made in consideration of the differences in the width, thickness, material, and the like between the first diaphragm portion and the second diaphragm portion.

What is claimed is:

1. A pressure sensor comprising:
a first diaphragm portion including a first pressure receiving surface, the first diaphragm port ion being deflected and deformed under a pressure received by the first pressure receiving surface;
a second diaphragm portion including a second pressure receiving surface arranged to be oriented in a direction different from the first pressure receiving surface, the second diaphragm portion being deflected and deformed under a pressure received by the second pressure receiving surface;
a first strain detecting element disposed in the first diaphragm portion and outputting a signal in response to a strain; and
a second strain detecting element disposed in the second diaphragm portion and outputting a signal in response to a strain, the second strain detecting element being connected in series to the first strain detecting element.

2. The pressure sensor according to claim 1, comprising a plurality of sets of the first strain detecting element and the second strain detecting element connected in series.

3. The pressure sensor according to claim 2, comprising:
the first strain detecting element whose output signal increases when the pressure received by the first pressure receiving surface increases;
the first strain detecting element whose output signal decreases when the pressure received by the first pressure receiving surface increases;
the second strain detecting element whose output signal increases when the pressure received by the second pressure receiving surface increases, and which is connected in series with the first strain detecting element whose signal increases; and
the second strain detecting element whose output signal decreases when the pressure received by the second pressure receiving surface increases, and which is connected in series with the first strain detecting element whose signal decreases.

4. The pressure sensor according to claim 1, comprising a bridge circuit including the first strain detecting element and the second strain detecting element.

5. The pressure sensor according to claim 1, comprising:
a first pressure reference chamber including a wall portion a portion of which is configured of the first diaphragm portion; and
a second pressure reference chamber including a wall portion a portion of which is configured of the second diaphragm portion.

6. The pressure sensor according to claim 5, wherein
the first pressure reference chamber and the second pressure reference chamber are in communication with each other.

7. The pressure sensor according to claim 5, wherein
at least one of the first pressure reference chamber and the second pressure reference chamber includes a wall portion having a stacked structure.

8. The pressure sensor according to claim 1, comprising a substrate supporting a first structure including the first diaphragm portion and a second structure including the second diaphragm portion.

9. The pressure sensor according to claim 8, wherein
the first structure is disposed on one surface side of the substrate, and
the second structure is disposed on the other surface side of the substrate.

10. The pressure sensor according to claim 8, wherein
the first structure and the second structure are both disposed on one surface side of the substrate.

11. The pressure sensor according to claim 1, comprising a container including an opening and accommodating a first structure including the first diaphragm portion and a second structure including the second diaphragm portion.

12. The pressure sensor according to claim 11, comprising a pressure transmission medium in the form of liquid or gel covering at least the first pressure receiving surface and the second pressure receiving surface in the container.

13. A portable apparatus comprising the pressure sensor according to claim 1.

14. A portable apparatus comprising the pressure sensor according to claim 2.

15. A portable apparatus comprising the pressure sensor according to claim 3.

16. An electronic apparatus comprising the pressure sensor according to claim 1.

17. An electronic apparatus comprising the pressure sensor according to claim 2.

18. An electronic apparatus comprising the pressure sensor according to claim 3.

19. A moving object comprising the pressure sensor according to claim 1.

20. A moving object comprising the pressure sensor according to claim 2.
